(19) United States
(12) Patent Application Publication
(10) Pub. No.: US 2023/0111338 A1
(43) Pub. Date: Apr. 13, 2023

(54) DETECTION OF CRITICAL OPERATING STATES OF A PTC HEATER

(71) Applicant: MAHLE International GmbH, Stuttgart (DE)

(72) Inventor: Matthias Schall, Ostfildern (DE)

(21) Appl. No.: 17/964,840

(22) Filed: Oct. 12, 2022

(30) Foreign Application Priority Data
Oct. 13, 2021 (DE) 10 2021 211 547.0

(51) Int. Cl. G05D 23/24; H05B 3/00

(52) U.S. Cl. CPC G05D 23/2401; H05B 3/0019; H05B 2203/02

(57) ABSTRACT

A method for regulating a PTC heating with at least one PTC heating element and a control unit for controlling the PTC heating element is disclosed. The method includes: controlling with the control unit the PTC heating element to a target output via a control variable; receiving via PTC heating element, with the target output of the control unit, an electrical input power and emitting a thermal heating output to an environment; in a testing step the control unit keeps the target output constant over a predefined plateau duration and checks the PTC heating element for a critical imbalance state where the PTC heating element regulates itself by an increasing of its resistance; and after the testing step, when the control unit detects the critical imbalance state, the control unit reduces the target output in a regulating step.

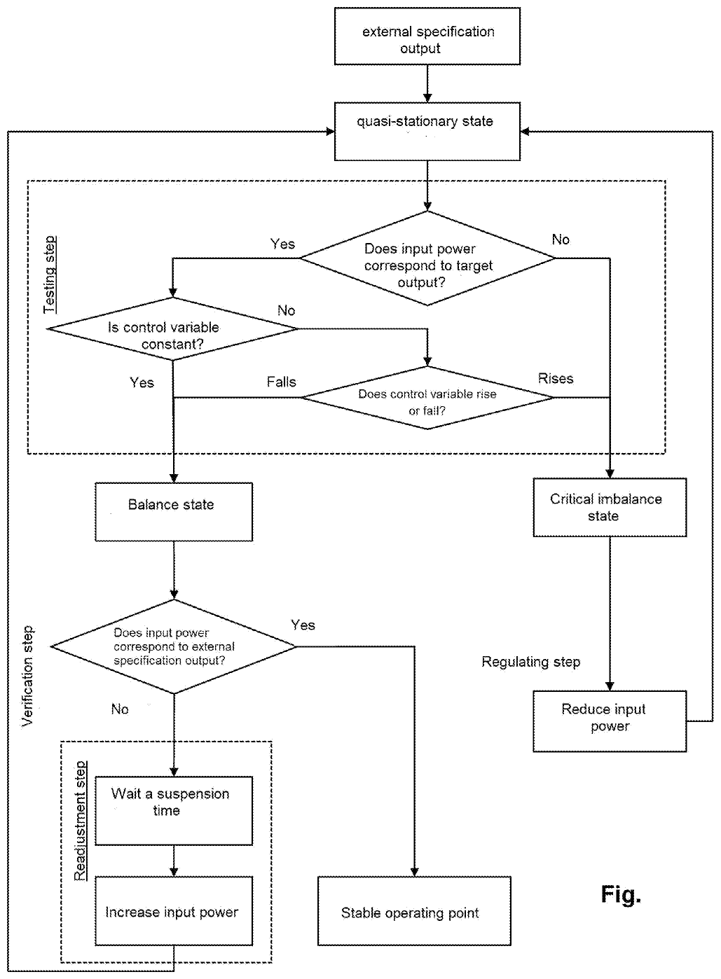

### CROSS-REFERENCE TO RELATED APPLICATION

This application claims priority to German Application No. DE 10 2021 211 547.0 filed on Oct. 13, 2021, the contents of which are hereby incorporated by reference in its entirety.

### TECHNICAL FIELD

The invention relates to a method for regulating a PTC heater with at least one PTC heating element and with a control unit. The invention also relates to the PTC heater.

### BACKGROUND

A PTC heater can be provided for example for an air-conditioning unit in a motor vehicle and usually comprises at least one PTC heating element and a control unit. The respective PTC heating element increases its electrical resistance in the case of rising temperatures, and reduces the electrical power consumption. Thereby, the PTC heating element can limit its temperature to a regulating temperature which is predetermined by its PTC material. However, the regulating temperature can disadvantageously be so high that the materials surrounding the respective PTC heating element can be damaged or respectively destroyed. In other words, the air temperatures after the PTC heating element can be so high that they lie above the permissible temperatures of individual components in the air path of the air-conditioning unit.

The regulating of the respective PTC heating element to the regulating temperature usually occurs when the heating output taken from the PTC heater reduces and the control unit of the PTC heater does not detect this. This can occur for example in the case of a fault or a misuse. In this case, the respective PTC heating element regulates the received output. The respective PTC heating element therefore regulates itself further until it reaches its regulating temperature. Here, the electrical power consumption is then minimal or respectively close to zero. Through this characteristic, the PTC heater is indeed intrinsically safe, however in such cases damage to the air-conditioning unit can occur.

The object of the invention is therefore to indicate for a method for regulating a PTC heater and for a PTC heater an improved or at least alternative embodiment, in which the described disadvantages are overcome.

This problem is solved according to the invention by the subject of the independent claim(s). Advantageous embodiments are the subject of the dependent claims.

### SUMMARY

The present invention is based on the general idea of detecting a power imbalance between electrically delivered power and power removed on the air side, and of turning down the PTC heater accordingly.

A method is provided for regulating a PTC heater. The PTC heating has here at least one PTC heating element and a control unit for controlling the respective PTC heating element. In the method, the control unit controls the respective PTC heating element to a target output by means of a control variable. With the predetermined target output of the control unit, the respective PTC heating element receives an electrical input power and emits a corresponding thermal heating output to the environment. According to the invention, the control unit keeps the target output constant over a predefined plateau duration in a testing step, and checks the respective PTC heating element for a critical imbalance state. The critical imbalance state is defined here in that the respective PTC heating element regulates itself by an increasing of its resistance. When the critical imbalance state of the respective PTC heating element is detected, the control unit reduces the target output after the testing step in a regulating step.

In the method according to the invention, the control unit can detect the critical imbalance state of the respective PTC heating element and can accordingly initiate the regulating of the respective PTC heating element. The critical imbalance state is defined here in that the input power is higher than the thermal output which can be emitted on the air side. Through the remaining or respectively excess input power, the PTC element heats itself up and regulates itself here through its PTC characteristics by an increasing of its resistance. In the method according to the invention, the heating up of the PTC heating element to the regulating temperature can therefore be prevented. The detecting of the critical imbalance state can be carried out advantageously in an application-specific manner. Through the method according to the invention, critical operating points in the PTC heater can be prevented. No cost-intensive adapting of hardware—such as for example of the materials surrounding the respective PTC heating element and/or of the PTC material of the respective PTC heating element itself—is necessary here. Thereby, a flexible and software-based solution is provided, which is able to be transferred to differing applications.

In the method, the control unit checks here whether a critical imbalance state or a balance state is present at the respective PTC heating element. In the balance state an—in a first approximation linear—correlation is present between the control variable and the electrical input power. The critical imbalance state, in contrast, is distinguished in that almost no correlation is present between the control variable and the electrical input power. In the balance state of the respective PTC heating element in addition a quasi-stationary state of the respective PTC heating element can be reached, wherein here with a constant control specification and with constant boundary conditions the respective PTC heating element has a constant input power. The boundary conditions can be predetermined here by the voltage and/or the ambient temperature and/or an air quantity flowing through the PTC heater.

In order to detect the balance state or the critical imbalance state of the respective PTC heating element, the control unit can check whether the electrical input power of the respective PTC heating element changes in the case of the constant target output. If the respective PTC heating element is in the balance state, the respective PTC heating element does not regulate itself and the input power remains constant. If, on the contrary, the respective PTC heating element is in the critical imbalance state, then the respective PTC heating element regulates itself and the input power changes. In particular, the resistance of the PTC heating element rises here, and the input power falls. Thereby, the control unit can detect whether the regulating step is carried out or not.

Advantageously, in the testing step the control unit can keep constant the target output over the predefined plateau duration between 1 second and 10 minutes, preferably between 10 seconds and 180 seconds. Preferably, the plateau duration here can be in a two-digit seconds range.

In the method, provision can be made that after the regulating step, the control unit passes again to the testing step. In this case, the control unit checks again whether the imbalance state is present and initiates corresponding further steps. If the critical imbalance state were to be further present in the respective PTC heating element, the control unit passes again to the regulating step.

The control unit can determine the critical imbalance state of the respective PTC heating element in the testing step when the electrical input power corresponds to the target output and the control value, correlating therewith, of the control variable at the respective PTC heating element rises. In this case, the removed thermal heating output is less than the target output and the temperature of the respective PTC heating element rises. With a rising temperature, the electrical resistance of the respective PTC heating element rises and accordingly the electrical input power of the respective PTC heating element falls. As the electrical input power falls, the control unit readjusts the electrical input power of the respective PTC heating element for reaching or respectively keeping the target output by an increasing of the control variable. The control unit can detect this behaviour as the critical imbalance state of the respective PTC heating element. In the critical imbalance state, almost no correlation is present between the control variable of the control unit and the electrical input power.

The control unit can also determine the critical imbalance state of the respective PTC heating element in the testing step when the electrical input power is less than the target output and a control value of the control variable is maximum at the respective PTC heating element. In this case, the removed thermal heating output—as already described above—is less than the target output and the temperature of the respective PTC heating element rises. The respective PTC heating element regulates itself and the control unit readjusts until no further readjustment is possible. Here, therefore, the respective PTC heating element is completely corrected without the electrical input power reaching the target output.

In addition, in the testing step the control unit can not determine a critical imbalance state and, accordingly, a balance state, at the respective PTC heating element when the electrical input power corresponds to the target output and a control value of the control variable is constant or falls at the respective PTC heating element. Here, a normal operation of the respective PTC heating element is present. Here, the respective PTC heating element emits the electrical input power entirely or almost entirely as the thermal heating output. In the balance state an—in a first approximation linear—correlation exists between the control variable of the control unit and the electrical input power.

In the method, in the regulating step the control unit can reduce the input power via a reducing of the control variable. The control variable can be, for example, a current PWM signal. The control unit here can be a PWM controller (PWM: pulse width modulation). Basically, further current controllers and/or power controllers are also conceivable.

In the method, provision can be made advantageously that after the testing step in the case of a balance state of the respective PTC heating element, the control unit checks in a verification step whether the electrical input power and/or the target output corresponds to an externally predetermined specification output. When the electrical input power and/or the target output corresponds to the externally predetermined specification output, the method is terminated. When the electrical input power and/or the target output does not correspond to the externally predetermined specification output, the control unit increases the electrical input power in a readjustment step via the control variable.

When the respective PTC heating element is in the balance state, the respective PTC heating element no longer regulates itself and a normal operation of the PTC heater is present. When the desired externally predetermined specification output is not reached, the heating output emitted by the respective PTC heating element is too low. The control unit then increases the electrical input power of the respective PTC heating element via the control variable. When the desired externally predetermined specification output is reached, the heating output emitted by the respective PTC heating element is sufficient. Here, the method is terminated and the PTC heater is further controlled in a manner known to the specialist in the art. In addition, provision can be made that the control unit increases the electrical input power in the readjustment step after a suspension time via the control variable. The suspension time can lie here between 1 second and 10 minutes, preferably between 10 seconds and 5 minutes. The externally predetermined specification output can be predetermined for example by a controller which is set by a user. After the readjustment step, the control unit can pass again to the testing step.

The invention also relates to a PTC heater with at least one PTC heating element and with a control unit for controlling the respective PTC heating element. The control unit is designed for carrying out the method described above. In order to avoid repetitions, reference is to be made at the this point to the above statements.

Further important features and advantages of the invention will emerge from the subclaims, from the drawing and from the associated figure description with the aid of the drawing.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawing and are explained more closely in the following description.

### BRIEF DESCRIPTION OF THE DRAWINGS

The FIGURE shows a flow chart of a method according to the disclosure.

### DETAILED DESCRIPTION

The single FIGURE shows a schematic course of a method 1 according to the invention. The method 1 is provided here for regulating a PTC heater with at least one PTC heating element and with a control unit for controlling the respective PTC heating element. In the method 1 the respective PTC heating element is controlled by the control unit to an external specification output via a control variable—for example a current PWM signal. For this, the control unit specifies to the respective PTC heating element a target output and the respective PTC heating element receives an input power. The respective PTC heating element emits a thermal heating output to the environment—for example to the air flowing through the PTC heater.

When the respective PTC heating element is in a balance state, the respective PTC heating element, with the constant control variable and with constant boundary conditions, has a constant input power. The boundary conditions here can be provided by the voltage and/or the ambient temperature and/or an air quantity flowing through the respective PTC heating element. In addition, an—in a first approximation linear—correlation is present between the control variable of the control unit and the electrical input power. When the control variable rises/falls by a predetermined percentage value—for example by 2%—the electrical input power also rises/falls by this predetermined percentage value—for example by 2%. When the respective PTC heating element is in a critical imbalance state, the control variable of the control unit and the electrical input power display no or a small correlation with one another.

The control unit can now detect in a testing step whether the respective PTC heating element is in the critical imbalance state or in the balance state. For this, the control unit checks whether the input power corresponds to the target output. When the input power does not correspond to the target output, the respective PTC heating element is in the critical imbalance state. The control unit passes directly to a regulating step.

When the input power corresponds to the target output, the control unit checks further in the testing step whether the control variable is constant. When the control variable is constant, the respective PTC heating element is in the balance state and the control unit passes to a verification step. When the control variable is not constant, the control unit checks whether the control variable is rising or falling. When the control variable falls, the respective PTC heating element is in the balance state and the control unit passes to the verification step already mentioned above. When the control variable rises, the respective PTC heating element is in the critical imbalance state and the control unit passes to the regulating step already mentioned above.

When the respective PTC heating element is therefore in the critical imbalance state, the regulating step is carried out after the testing step. When the respective PTC heating element is in the balance state or respectively is not in the critical imbalance state, the verification step is carried out.

In the regulating step, the control unit reduces the input power of the respective PTC heating element via a reducing of the control variable. By way of example, in the regulating step the control unit can reduce the target output, determined by the control variable, via the control variable with 0.5% per second over 5 seconds—therefore in total by 2.5%. Thereafter, the control unit can pass again to the testing step and keep constant the set target output over the predefine plateau duration of 5-10 seconds and check whether the balance state is reached. When the balance state is not reached, after the testing step the control unit passes to the regulating step again and can reduce the target output further with 0.5% per second over 5 seconds—therefore in total by a further 2.5%.

In the verification step the control unit checks whether the input power corresponds to the external specification output. When the input power corresponds to the external specification output, the heating output emitted by the respective PTC heating element is sufficient and a stable operating point is reached. The method is terminated. When the input power does not correspond to the external specification output, the heating output emitted by the respective PTC heating element is not sufficient for heating and the control unit passes to a readjustment step. In the readjustment step the control unit waits a predetermined suspension time and thereafter increases the input power via the increasing of the control variable. Thereafter, the control unit passes again to the testing step.

In the method according to the invention, the control unit detects whether the respective PTC heating element is in the critical imbalance state or in the balance state. When the respective PTC heating element is in the critical imbalance state, the control unit can initiate the regulating of the respective PTC heating element. Thereby, critical operating points in the PTC heater are prevented. The method offers in addition a flexible and software-based solution which is able to be transferred to differing applications.

1. A method for regulating a PTC heater with at least one PTC heating element and with a control unit for controlling at least one PTC heating element, comprising:
controlling with the control unit the at least one PTC heating element to a target output via a control variable;
receiving via the at least one PTC heating element, with the target output of the control unit an electrical input power and emitting a thermal heating output to an environment;
in a testing step the control unit keeps the target output constant over a predefined plateau duration and checks the at least one PTC heating element for a critical imbalance state where the at least one PTC heating element regulates itself by an increasing of its resistance; and
after the testing step, when the control unit detects the critical imbalance state of the at least one PTC heating element, the control unit reduces the target output in a regulating step.

2. The method according to claim 1, wherein in the testing step the control unit keeps the target output constant over the predefined plateau duration between 1 second and 10 minutes.

3. The method according to claim 1, wherein after the regulating step the control unit passes again to the testing step.

4. The method according to claim 1, wherein in the testing step the control unit determines the critical imbalance state at the at least one PTC heating element when the electrical input power corresponds to the target output and a control value of the control variable rises at the at least one PTC heating element.

5. The method according to claim 1, wherein in the testing step the control unit determines the critical imbalance state at the at least one PTC heating element when the electrical input power is less than the target output and a control value of the control variable is maximum at the at least one PTC heating element.

6. The method according to claim 1, wherein in the testing step the control unit does not determine a critical imbalance state and a balance state at the at least one PTC heating element when the electrical input power corresponds to the target output and a control value of the control variable at the at least one PTC heating element is constant or falls.

7. The method according to claim 1, wherein after the testing step with a balance state of the at least one PTC heating element, where the at least one PTC heating element does not regulate itself by an increasing of its resistance, the control unit checks in a verification step whether at least one of the electrical input power and the target output corresponds to an externally predetermined specification output.

8. The method according to claim 7, wherein:
when the at least one of the electrical input power and the target output corresponds to the externally predetermined specification output, the method is terminated; and
when the at least one of the electrical input power and the target output does not correspond to the externally predetermined specification output, the control unit increases the electrical input power via the control variable in a readjustment step.

9. The method according to claim 7, wherein the control unit increases the electrical input power in a readjustment step after a suspension time via the control variable.

10. The method according to claim 7, wherein after a readjustment step, the control unit passes again to the testing step.

11. A PTC heater, comprising:
at least one PTC heating element and a control unit for controlling the at least one PTC heating element;
the control unit configured to control the at least one PTC heating element to a target output via a control variable, wherein with the target output of the control unit the at least one PTC heating element receives an electrical input power and emits a thermal heating output to an environment;
in a testing step, the control unit keeps the target output constant over a predefined plateau duration and checks the at least one PTC heating element for a critical imbalance state where the at least one PTC heating element regulates itself by an increasing of its resistance; and
after the testing step, when the control unit detects the critical imbalance state of the at least one PTC heating element, the control unit reduces the target output in a regulating step.

12. The PTC heating according to claim 11, wherein in the testing step the control unit keeps the target output constant over the predefined plateau duration between 1 second and 10 minutes.

13. The PTC heating according to claim 11, wherein after the regulating step the control unit passes again to the testing step.

14. The PTC heating according to claim 11, wherein in the testing step the control unit determines the critical imbalance state at the at least one PTC heating element when the electrical input power corresponds to the target output and a control value of the control variable rises at the at least one PTC heating element.

15. The PTC heating according to claim 11, wherein in the testing step the control unit determines the critical imbalance state at the at least one PTC heating element when the electrical input power is less than the target output and a control value of the control variable is maximum at the at least one PTC heating element.

16. The PTC heating according to claim 11, wherein in the testing step the control unit does not determine a critical imbalance state and a balance state at the at least one PTC heating element when the electrical input power corresponds to the target output and a control value of the control variable at the at least one PTC heating element is constant or falls.

17. The PTC heating according to claim 11, wherein after the testing step with a balance state of the at least one PTC heating element, where the at least one PTC heating element does not regulate itself by an increasing of its resistance, the control unit checks in a verification step whether at least one of the electrical input power and the target output corresponds to an externally predetermined specification output.

18. The PTC heating according to claim 17, wherein:
when the at least one of the electrical input power and the target output corresponds to the externally predetermined specification output, the method is terminated; and
when the at least one of the electrical input power and the target output does not correspond to the externally predetermined specification output, the control unit increases the electrical input power via the control variable in a readjustment step.

19. The PTC heating according to claim 18, wherein the control unit increases the electrical input power in the readjustment step after a suspension time via the control variable.

20. The PTC heating according to claim 19, wherein after the readjustment step, the control unit passes again to the testing step.
